(19) United States
(12) Patent Application Publication
(10) Pub. No.: US 2002/0148065 A1
(43) Pub. Date: Oct. 17, 2002

(54) Bicycle hub cleaning device

(76) Inventor: Robert J. Trent, Coquitlam (CA)

Correspondence Address: Robert J. Trent, 602 Clearwater Way, Coquitlam, BC, V3C 5E5, CA

(21) Appl. No.: 09/792,520

(22) Filed: Feb. 26, 2001

(51) Int. Cl. B60C 1/00

(52) U.S. Cl. 15/256.5; 280/158.1

(57) ABSTRACT

The present invention provides a strap, preferably made of pliant leather, with a method of easily and securely attaching its two ends together such that it forms a loop around the hub of a bicycle wheel. As the bicycle wheel spins, the loop naturally moves about on the hub and removes oil and dirt from the hub. The strap includes a pattern of cuts along its two long edges and has a rough inner surface to assist in cleaning and includes an optically reflective outer surface for rider safety. The size of the strap is approximately 16 cm long by 1.4 cm wide by 1 mm thick so that it is large enough to freely spin on the hub yet not too large as to strike the spokes and create unwanted noise. The method of attaching its two ends comprise one or more holes at one end of the strap and an arrowhead with one or more pairs of notches at the other end of the strap. In connecting different notches and holes together, different sized loops may be formed. In another embodiment of the present invention, the arrowhead includes a tab that feeds easily through the selected hole and assists in pulling the arrowhead through the hole. In another embodiment of the present invention, the method of attaching its two ends comprise hook and loop material, which also allows for various loop sizes. In another embodiment of the present invention, the method of attaching its two ends comprise a snap and a complementary snap retainer.

### CROSS-REFERENCE TO RELATED APPLICATIONS

Not applicable.

### BACKGROUND

1. Field of the Invention

The present invention relates to bicycle accessories and more particularly to a device specifically designed to be installed around a bicycle wheel hub and clean the hub while the bicycle wheel is spinning.

2. Description of Prior Art

The bicycle component located in the center of a wheel from which the spokes radiate outward is known as the hub. A plurality of bicycle hub designs have been in use since the invention of the bicycle in the 19^{th} century.

Coaster brakes have been popular on bicycles for most of the 20^{th} century. Coaster brakes consist of a hub brake and a freewheel that are contained inside the back hub of the bicycle and operate in oil or grease. Backpedaling forces brake shoes or brake discs against the inside of the hub shell, stopping the bicycle.

Several variations of hubs, especially of the coaster brake variations, have included a grease nipple on the hub to lubricate the internal mechanisms. Oil and grease from the hub, through leakage or spillage, frequently coats the outside surfaces of such hubs, attracting dirt.

Most modern bicycles utilize hand brakes and thus do not include a coaster brake mechanism in the rear hub. Furthermore, sealed bearing designs are typically found on both the front and rear hubs of most modern bicycles, eliminating the need for a grease nipple and regular maintenance. However, oil and dirt still build up on the hubs from other moving bicycle components, such as the chain, and from dirt thrown up from the tires. This is especially true of modern day mountain bikes, which are ruggedly built and can be used in extremely muddy, wet, or dusty conditions.

Although most components of a bicycle can be easily cleaned by hand, cleaning a bicycle hub is often challenging. The area around a bicycle hub is typically densely surrounded by spokes and allows only limited access to the hub. A washcloth or brush in not able to easily reach into such a confined space, and spraying water onto the hub typically is not able to adequately remove grease and oil.

### SUMMARY OF THE INVENTION

The present invention is a strap, with both ends connected together, such that it forms a loop around a bicycle hub. As the bicycle wheel spins, the loop naturally moves about on the hub and removes oil and dirt from the hub. The hub is continuously cleaned and polished by the loop while the wheel spins, eliminating the need to ever clean the hub by hand.

The strap incorporates many features to assist in its ability to clean and polish the hub. The long edges of the strap include serrations that are able to extend into the irregular shaped outer edges of the hub. They also chisel dried mud from the hubs more effectively than a straight edge.

The strap is typically made of leather with a rough surface, such as the surface found on suede leather. Other similar natural or artificial materials may be used in place of the leather. The rough surface is more effective than a smooth surface at removing dirt and oil. The leather is pliant and is able to wrap around a portion of the hub, providing effective cleaning of the hub's surface. The leather is also strong, resisting breakage, and does not generate noise while moving on the hub. With a thickness of approximately 1 mm, the leather will form easily into a loop. If the leather is much thinner, the strap could quickly wear thin and break. If the leather is much thicker, the strap cannot be formed easily into a loop and will not form to the surface of the hub, thereby reducing its cleaning effectiveness.

The size of the strap is approximately 16 cm by 1.4 cm. This sized strap results in a loop that will fit most popular bicycle wheel hubs. The loop will be large enough to be able to freely turn and move back and forth on the hub with the bicycle wheel is spinning. This ensures that the strap cleans the entire surface of the hub. A larger sized loop may have the problem of striking the spokes of the bicycle wheel while moving and spinning on the hub, resulting in undesirable noise.

Rider safety is improved with the inclusion of a reflective surface on the outer surface of the loop, improving the ability of an automobile driver to see at night a bicyclist using the present invention when illuminated with artificial lights, such as the headlights of an automobile.

In a preferred embodiment of the invention, the strap consists of an arrowhead shape at the top end of the strap with one pair of notches beneath the arrowhead. One notch is cut into one long side of the strap and the other notch is cut into the other long side of the strap such that each notch of the pair of notches is positioned directly across from the other. At the bottom end of the strap, one hole is included that is centrally located between the two long edges of the strap.

The two ends of the strap are connected together by feeding the arrowhead shape through the hole until the pair of notches line up with the hole. The hole is then seated between the pair of notches and the strap is connected together to form a loop. The arrowhead is deformed as it feeds through the hole and must be forcefully pushed or pulled through the hole. Typically, the sides of the arrowhead will fold inwards as it feeds through the hole, allowing the full body of the arrowhead to fit through the hole.

This method of attachment allows the strap to be quickly and easily attached around the hub of a bicycle wheel. It is also secure and cost-effective to manufacture.

The hole may be any number of shapes, including round or rectangular, but it is ideally a narrow slot in shape. The slot shape hole is firmly held between the pair of notches and prevents the loop from reforming while the bicycle wheel is spinning.

In an alternate embodiment of the invention, the arrowhead shape includes a tab that is slightly narrower than the width of the hole in the strap. The tab is therefore easy to thread through the hole. Once the tab is thread through the hole, the larger arrowhead shape can be pulled through the hole until the hole is seated between the pair of notches. In this manner, the tab improves the ease at which the arrowhead can be threaded and pulled through the hole. Without this tab, an installer may struggle to feed the arrowhead through the hole of the strap.

In an alternate embodiment of the invention, there is more than one pair of notches but only one hole on the strap. These pairs of notches are spaced along the long edges of the strap. With multiple pairs of notches, the loop may be formed into multiple sizes to better fit the hub on which it is being installed. The installer of the loop pulls the arrowhead through the hole and then positions the hole in the pair of notches that provides the optimum size of loop. Although not necessary, any excess strap may be cut away after installation.

In an alternate embodiment of the invention, there is more than one hole but only one pair of notches on the strap. These holes are spaced, one after another, centrally between the two long edges of the strap and at the bottom end of the strap. With multiple holes, the loop may be formed into multiple sizes to better fit the hub on which it is being installed. The installer of the loop pulls the arrowhead through the hole that provides the optimum size of loop and then positions the hole in the pair of notches. Although not necessary, any excess strap may be cut away after installation.

An alternate embodiment of the invention replaces the arrowhead, notch pairs, and holes with the use of hook and loop attachments, such as a Velcro brand attachment, to connect the two ends of the strap. The hook material is present on the top end of the front surface of the strap and the loop material is present on the bottom end of the back surface of the strap. This ensures that the loop can be formed without creating a twist in the strap. This attachment technique results in very quick and easy installation of the strap. The hook and loop attachment also allows the strap to be easily fitted to various hub sizes.

An alternate embodiment of the invention replaces the arrowhead, notch pairs, and holes with the use of snap and a complementary snap retainer to connect the two ends of the strap. The snap is present on the top end of the front surface of the strap and the complementary snap retainer is present on the bottom end of the back surface of the strap. This ensures that the loop can be formed without creating a twist in the strap. This attachment technique results in very quick and easy installation of the strap.

### DRAWING FIGURES

For a better understanding of the invention, reference is made to the following detailed description of the present invention which is to be read and understood in conjunction with the accompanying drawings wherein. In the drawings, closely related figures have the same number but different alphabetic suffixes:

FIG. 1 illustrates the strap installed on the hub of a bicycle wheel;

FIG. 2A illustrates a preferred embodiment of the invention with serrations and a reflective surface and with the method of attachment comprising the use of a hole, arrowhead, and pair of notches;

FIG. 2B illustrates another embodiment of the invention with the inclusion of a tab at the top of the arrowhead;

FIG. 3A illustrates the method of inserting the tab at the top of the arrowhead into the hole;

FIG. 3B illustrates the strap with both ends connected together;

FIG. 4A illustrates another embodiment of the invention with the hole and a plurality of pairs of notches;

FIG. 4B illustrates another embodiment of the invention with a plurality of holes and the single pair of notches;

FIG. 5 illustrates another embodiment of the invention with the method of attachment comprising the use of a hook and loop attachment material; and,

FIG. 6 illustrates another embodiment of the invention with the method of attachment comprising the use of a snap and a complementary snap retainer.

Reference Numerals in Drawings

| | |
|---|---|
| 10 strap | 30 tab |
| 12 bicycle wheel | 32 hook material |
| 14 hub | 34 loop material |
| 16 spokes | 36 top end |
| 18 rim | 38 front surface |
| 20 hole | 40 bottom end |
| 22 pair of notches | 42 back surface |
| 24 arrowhead | 44 snap |
| 26 serrated edges | 46 complementary snap retainer |
| 28 reflective surface | |

### DETAILED DESCRIPTION

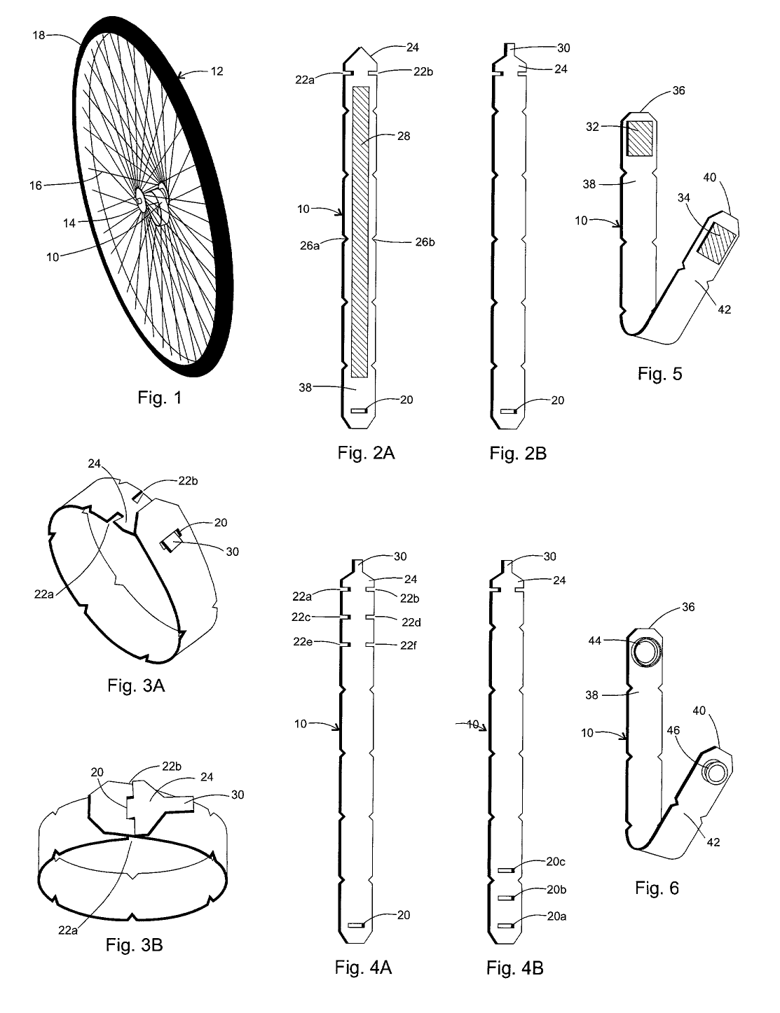

Referring initially to FIG. 1, an embodiment of the strap 10 made in accordance with the present invention is shown installed on a hub 14 of a bicycle wheel 12. Bicycle wheel 12 consists of hub 14, spokes 16, and a rim 18. As bicycle wheel 12 spins the loop formed by strap 10 spins and moves back and forth on hub 14, polishing hub 14 of any dirt or oil buildup. Spokes 16 prevent easy access to hub 14 for traditional cleaning with a brush or washcloth.

Referring now to FIG. 2A, the invention is shown with the method of attachment comprising the use of a hole 20, a pair of notches 22a and 22b, and an arrowhead 24. Serrated edges 26a and 26b improve the hub cleaning effectiveness of strap 10. A reflective surface 28 allows the rider to be seen at night and is positioned on the front surface 38 of strap 10.

Referring now to FIG. 2B, an alternate embodiment of the invention includes a tab 30 at the top of arrowhead 24 to assist in feeding arrowhead 24 through hole 20.

Referring now to FIG. 3A, the method of inserting tab 30 at the top of arrowhead 24 into hole 20 is illustrated. The installer's thumb and index finger grip tab 30 which has been threaded easily through hole 20. The installer then pulls tab 30, which forces arrowhead 24 to deform and feed through hole 20 such that pair of notches 22a and 22b are seated in hole 20.

Referring now to FIG. 3B, the invention is shown with both ends connected together. Tab 30 and arrowhead 24 have been fed through hole 20. Hole 20 is in the shape of a rectangular slot such that it is firmly seated between pair of notches 22a and 22b.

Referring now to FIG. 4A, an alternate embodiment of the invention with a plurality of pairs of notches 22a, 22b, 22c, 22d, 22e, and 22f is shown. An installer may threat tab 30 and arrowhead 24 through hole 20 and seat any one of pairs of notches 22a, 22b, 22c, 22d, 22e, and 22f in hole 20 to optimize the strap length to the size of the hub. Any number of notches may be used in strap 10.

Referring now to FIG. 4B, an alternate embodiment of the invention with a plurality of holes 20a, 20b, and 20c is shown. An installer may thread tap 30 and arrowhead 24 through any of holes 20a, 20b, and 20c to optimize the strap length to the size of the hub. Any number of holes may be used in strap 10.

Referring now to FIG. 5, an alternate embodiment of the invention with a hook material 32 and a loop material 34 attachment replacing the arrowhead and hole is shown. Hook material 32 is attached to the top end 36 of the front surface 38 of strap 10. Loop material 34 is attached to the bottom end 40 of the back surface 42 of strap 10, such that strap 10 requires no twists when both ends are connected together.

Referring now to FIG. 6, an alternate embodiment of the invention with a snap 44 and a complementary snap retainer 46 attachment replacing the arrowhead and hole is shown. Snap 44 is attached to the top end 36 of the front surface 38 of strap 10. Complementary snap retainer 46 is attached to the bottom end 40 of the back surface 42 of strap 10, such that strap 10 requires no twists when both ends are connected together.

While the present invention has been described herein with respect to the exemplary embodiments and the best mode for practicing the invention, it will be apparent to one of ordinary skill in the art that many modifications, improvements and subcombinations of the various embodiments, adaptations and variations can be made to the invention without departing from the spirit and scope thereof.

What is claimed is:

1. A bicycle hub cleaning device that attaches around a hub of a bicycle wheel and cleans oil and dirt from said hub while said bicycle wheel spins, comprising:
a strap;
a means of attachment to connect the top end of said strap to the bottom end of said strap whereby said strap forms a loop around said hub.

2. The device of claim 1 wherein said means of attachment comprises:
a plurality of holes at or near the bottom end of said strap positioned centrally between the two long edges of said strap;
an arrowhead shape at the top end of said strap above a plurality of pairs of notches;
the two notches in each said pairs of notches each positioned across from each other on the two long edges of said strap.

3. The device of claim 2 wherein said arrowhead may be deformed and forcefully fed through a single selected hole of said holes, and said single selected hole may be seated between a single selected pair of notches of said pairs of notches whereby the top end and bottom end of said strap are connected.

4. The device of claim 3 wherein said holes are slotted openings in said strap whereby said single selected hole is firmly seated between said single selected pair of notches and said loop will not deform while said bicycle wheel is spinning.

5. The device of claim 3 further including a tab at the top of said arrowhead that can be easily fed through said single selected hole before said arrowhead is pulled through said single selected hole whereby the difficulty of feeding and pulling said arrowhead through said single selected hole is reduced.

6. The device of claim 2 wherein the bottom end of said strap has only one of said holes and the top end of said strap has only one of said pairs of notches whereby only a single size of said loop may be formed.

7. The device of claim 2 wherein the bottom end of said strap has only one of said holes and the top end of said strap has a plurality of said pairs of notches whereby a plurality of different sizes of said loop may be formed.

8. The device of claim 2 wherein the bottom end of said strap has a plurality of said holes and said top end of said strap has only one of said pairs of notches whereby a plurality of different sizes of said loop may be formed.

9. The device of claim 1 wherein said means of attachment comprises the use of a hook and loop attachment material whereby said loop with a plurality of sizes can be formed quickly and easily with said strap.

10. The device of claim 9 wherein the hook material of said hook and loop attachment material is present on the top end of the front surface of said strap and the loop material of said hook and loop material is present on the bottom end of the back surface of said strap whereby said loop around said hub requires no twists in said strap.

11. The device of claim 1 wherein said means of attachment comprises the use of a snap and a complementary snap retainer whereby said loop can be formed quickly and easily with said strap.

12. The device of claim 11 wherein said snap is present on the top end of the front surface of said strap and said complementary snap retainer is present on the bottom end of the back surface of said strap whereby said loop around said hub requires no twists in said strap.

13. The device of claim 1 wherein the two long edges of said strap have cut into them an irregular or regular pattern of serrations or notches or teeth or grooves whereby the ability of said strap to clean and polish said hub is improved.

14. The device of claim 1 further including an optically reflective material attached to the outer surface of said loop whereby automobile headlights may be reflected by said optically reflective material at night allowing a bicycle rider to be seen by an automobile driver.

15. The device of claim 1 wherein said strap is made of leather or a substantially similar natural or synthetic material whereby said loop is pliant enough to wrap around a portion of said hub to accomplish cleaning and polishing and said loop is substantially quiet as said bicycle wheel spins and said loop is strong enough to not easily break.

16. The device of claim 1 wherein the surface of said strap is substantially rough whereby said hub is cleaned and polished by said loop while said bicycle wheel spins.

17. The device of claim 1 wherein the thickness of said strap is approximately 1 mm whereby said loop is pliant enough to wrap around a portion of said hub to accomplish cleaning and polishing and said loop is strong enough to not easily break.

18. The device of claim 1 wherein said strap has a short edge length of approximately 1.4 cm and a long edge length of approximately 16 cm whereby said loop is large enough to freely spin and move back and forth on said hub while said bicycle wheel spins and said loop is not so large as to strike the spokes of said bicycle wheel resulting in undesirable noise.
